(19) United States
(12) Patent Application Publication
(10) Pub. No.: US 2004/0037961 A1
(43) Pub. Date: Feb. 26, 2004

(54) Production of surfaces to which liquids do not adhere

(76) Inventors: Cedric Dieleman, Scheibenhard (FR); Harald Keller, Ludwigshafen (DE); David Quere, Paris (FR); Aurelie Lafuma, Paris (FR)

Correspondence Address: Herbert B. Keil, KEIL & WEINKAUF, 1350 Connecticut Ave., N.W., Washington, DC, 20036, US

(21) Appl. No.: 10/644,924

(22) Filed: Aug. 21, 2003

(30) Foreign Application Priority Data
Aug. 26, 2002 (DE) 10239071.1

(51) Int. Cl. B05D 3/02

(52) U.S. Cl. 427/372.2

(57) ABSTRACT

The present invention relates to a process for producing surfaces on which, at a temperature T≧T1, liquids A do not adhere or adhere only poorly, and in particular for producing surfaces with low susceptibility to soiling. The invention also relates to articles which have at least one such surface.

The present invention relates to a process for producing surfaces to which, at a temperature T≧T1, liquids A do not adhere or adhere only poorly, and in particular for producing surfaces with low susceptibility to soiling. The invention also relates to articles which have at least one such surface.

Conventional surfaces are generally wetted by liquids. The degree of wetting depends on interplay between the cohesion forces within the liquid and the adhesion forces between liquid and surface. The contact angle of a liquid droplet on a surface is frequently utilized as a measure of the wettability of that surface by the liquid (see Barthlott et al., Biologie in unserer Zeit, 28, No. 5, 314-322; K. Henning, SÖFW-Journal, Chemische Spezialitäten 127 (2001), pp. 96-107). Another measure of the adhesion of a liquid on a surface, i.e. the adhesion of liquid droplets on a surface, is the contact angle hysteresis. The contact angle hysteresis Δθ=θₐ−θᵣ is the difference between the advancing contact angle θₐ and the receding contact angle θᵣ for a liquid droplet running off a surface (Dörfler in Grenzflächen und kolloiddisperse Systeme, Springer-Verlag Berlin Heidelberg New York 2002, pp. 85-88). The greater the contact angle hysteresis, the stronger the adhesion of the liquid droplet to the surface, and the smaller the running-off tendency of liquid droplets on inclined surfaces. The same applies to the wettability of the surface by a liquid.

The prior art defines the contact angle θ as the angle enclosed by said surface and a tangent along the surface of the liquid droplet in the region of the location of contact of the liquid droplet with the surface, the contact angle being measured through the liquid droplet. The advancing contact angle θₐ is the contact angle of the droplet on the side in the direction of movement, and the receding contact angle θᵣ is the contact angle on the side opposite to the direction of movement. The static contact angle for a droplet at rest is a different parameter (see Dörfler, loc. cit. Sections 4.7 and 4.8, pp. 87 et seq.).

The soiling of surfaces is a general occurrence in everyday life, both in households and in industry. Laborious cleaning work is needed to remove stains or dirt. A typical example is provided by ring-shaped stains produced during drying-out of water or aqueous solutions, e.g. stains resulting from hard water, raindrops, and the like. Stains resulting from coffee, tea, juices, or red wine are particularly problematic. Other examples of undesirable dirt are provided by soot, dust, spores, pollen, and bacteria. These contaminants are not only unsightly but can also cause degradation of coatings and surfaces and result in hygiene problems, particularly in hospitals, abattoirs, and sanitary installations.

The soiling of surfaces is closely related to the wettability of the surface by liquids (see Barthlott et al., Biologie in unserer Zeit, 28, No. 5, 314-322; K. Henning, SÖFW-Journal, 127 (2001), pp. 96-107) and the adhesion of liquid droplets to a surface. For example, a result of the wetting of surfaces with water is that water droplets remain on the surface and evaporate, whereupon the solids dissolved or suspended in water remain on the surface as undesirable residues. This problem is particularly in evidence with surfaces exposed to rainwater. The wetting of a surface with water also frequently initiates its corrosion or infestation with microorganisms, or else its colonization by algae, lichens, mosses, bivalves, etc. This in turn results in biocorrosion of the surface.

It is also known that dirt particles on rough, hydrophobic surfaces are washed away from the surface by moving water (see Barthlott et al., loc. cit. and WO 96/04123). This effect stems from the low adhesion of the water droplets on the rough, hydrophobic surfaces, and is also termed the self-cleaning effect or Lotus effect.

EP-A 933 388 discloses a process for producing structured surfaces with hydrophobic properties, by firstly producing a negative mold by photolithography, using this mold to emboss a plastic film, and then hydrophobicizing the plastic film with fluoroalkylsilanes.

EP-A 909 747 describes a process for generating self-cleaning properties on ceramics, such as roof tiles, by applying a dispersion of clay particles in an organic silicone resin solution to the ceramic and curing the coating.

The methods described in the prior art for producing low-wettability surfaces are generally very complicated and frequently do not give satisfactory results. Another disadvantage of the known low-wettability surfaces is their susceptibility to surfactant-containing liquids and oil- or fat-containing contaminants. The known low-wettability surfaces frequently have an unsightly matt appearance.

It is an object of the present invention, therefore, to provide another process for producing surfaces to which liquids have low adhesion. The process should permit the controlled production of the surfaces of this type to which liquids other than water exhibit low adhesion. The process should also be simple to carry out and should minimize the disadvantageous effect on the appearance of the surfaces.

We have found that this object is achieved, surprisingly, by means of a process in which a substance B which is immiscible with the liquid A or soluble therein to an extent of less than 0.1 g/l (at 20° C. and 1013 mbar) and has been selected from low-molecular-weight, oligomeric, or polymeric liquids is applied to a surface S present on a substrate or an article and having any depressions and/or elevations, the average distance between adjacent elevations being in the range from 0.01 to 500 μm, and the average height difference between mutually adjacent elevations and depressions is in the range from 0.01 to 500 μm, where the amount applied covers the surface.

The term liquid used here means substances B which, at the lowest desired usage temperature T1, remain liquid or, in the case of polymeric liquids, have no flow threshold. The flow threshold is defined as the minimum shear stress above which a plastic material has the rheological behavior of a liquid. A plastic material which has no measurable flow threshold therefore has the rheological behavior of a liquid even when no measurable shear stress is applied. The external forces required for its flow are therefore zero or only tiny (see Römpp-Lexikon, Lacke und Druckfarben, Georg-Thieme-Verlag 1998, Stuttgart, p. 239).

The present invention therefore provides a process for producing articles or substrates with at least one surface on which a liquid A has low adhesion at a temperature T≧T1, by applying a substance B in liquid or in dissolved form to a surface S of the substrate or article in an amount which covers the surface S, which comprises using a surface S which has many depressions and elevations, where the average distance between adjacent elevations is in the range from 0.01 to 500 μm and the average height difference between mutually adjacent elevations and depressions is in the range from 0.01 to 500 μm, the substance B is immiscible with the liquid A and soluble therein to an extent of less than 0.1 g/l (at 20° C. and 1013 mbar), and has been selected from low-molecular-weight and oligomeric substances B1 which are liquid at the temperature T1 and polymeric liquids, i.e. plastic polymeric substances B2 which do not have a measurable flow threshold.

The terms advancing contact angle, receding contact angle, static contact angle and contact angle hysteresis are used here and below in accordance with the definitions which were mentioned at the outset and are conventional in the prior art. The contact angle is determined by methods known per se, for example with the aid of a microscope equipped with a goniometer (see Dörfler, loc. cit., pp. 75 et seq., and C. D. Bain et al., Angew. Chem. 101 (1989) 522-528, and A. Born et al., Farbe & Lack 105 (1999) pp. 96-104).

The nature of the substance B depends on the liquid A and on the nature of the surface for which low wettability is to be achieved. Firstly, the substance B has to be immiscible with the liquid A or soluble therein to an extent of less than 0.1 g/l, preferably less than 0.05 g/l, and in particular less than 0.01 g/l (at 20° C. and 1013 mbar).

Preference is given here to those substances B which, at T≧T1, have a static contact angle θ_{B}<10° (e.g. at 20° C.) on the surface, or have no measurable contact angle. This makes coating of the substrate surface easier.

It is self-evident that the substance B should have only low volatility at the usage temperature, in order to ensure durability of the coating. In particular, the vapor pressure of the substance B at the usage temperature, and as a minimum requirement at 20° C., should not exceed 0.1 mbar, in particular 0.01 mbar, or the boiling point of the substance B at atmospheric pressure should not be less than 200° C., in particular should not be less than 250° C.

If the substance B is a polymeric substance B2, according to the invention the minimum requirement is that at the temperature T1 the substance has no measurable flow threshold, i.e. the substance B2 is capable of undergoing plastic deformation, and is therefore flowable, when subjected to no, or only tiny, shear stresses. This is generally the case when the polymeric substance B2 has substantially no crosslinking and has no crystalline domains.

The lower limit of the usage temperature T1, above which there is a marked reduction in the adhesion of the liquid A, depends substantially only on whether at that temperature the substance B is liquid or has no flow threshold. The upper limit of the temperature, at which no, or only slight, wetting takes place depends only on the stability of the coating. In principle, therefore possible usage temperatures are in the range from −60 to 250° C., in particular in the range from −20 to 200° C., and specifically in the range from −10 to 150° C. Correspondingly, the value for T1 used as a basis for selecting suitable substances B will frequently be a temperature ≧−60° C., in particular ≧−20° C., and specifically ≧−10° C. Low wettability is frequently desired at temperatures ≧−10° C., e.g. from −10 to 100° C., and in particular from 0 to 50° C. In this case, this value for T1 will be used as a basis for selecting the substance B. One preferred embodiment of the invention therefore provides a process which uses a substance B which is liquid at −10° C. and in particular, as a minimum requirement, at 0° C., or as an alternative has no flow threshold at −10° C. or, respectively, 0° C. and above. If the polymeric substance has a glass transition, the associated glass transition temperature is preferably below T1 by at least 5 K, in particular at least 10 K, and specifically by 20 K. Preference is therefore given here to those substances B2 whose glass transition temperature is ≦−5° C., in particular ≦−10° C., and specifically ≦−20° C.

If the low wettability is desired only at relatively high temperatures, e.g. ≧50° C., this temperature T1 will be used as a basis for selecting suitable substances. One embodiment of the invention therefore provides a process for which T is ≧50° C., and the substance B has the required properties at 50° C. and above.

With regard to the desired effect of low adhesion of the liquid A to the surface obtained according to the invention, the selection of the substance B is preferably such that it complies with the relationship of formula I

γ_{B}* cos(θ_{B})−γ_{A}* cos(θ_{A})−γ_{A/B}>0 (I)

where

γ_{A} is the surface tension of the liquid A

θ_{A} is the static contact angle of the liquid A on the untreated surface S

γ_{B} is the surface tension of the substance B

θ_{B} is the static contact angle of the liquid substance B on the untreated surface S, and

γ_{A/B} is the surface tension at the boundary between liquid A and substance B.

The terms surface tension at the boundary, surface tension, and static contact angle in formula I have the conventional prior-art meaning (see, for example, Dörfel, loc. cit., Römpp, Chemielexikon, 10th Edition, pp. 1608 and 2975 et seq.) and relate to the values applying at the temperature T1. If T1≧−10° C. and in particular ≧0° C., γ_{A}, γ_{B}, θ_{A}, θ_{B}, and γ_{A/B} may be based on the values applicable under standard conditions (25° C. and 1013 mbar). The values for γ_{A}, γ_{B}, and γ_{A/B} may frequently be taken from the literature, e.g. from commercial databases, such as Winspirs Version 4.01, Silver Platter Software©, Silver Platter Ltd. N.V. 1999, and relevant manuals.

The surface tension γ_{A} of the liquid A and the surface tension γ_{B} of the substance B may be determined in a manner known per se, e.g. by (a) formation of meniscus and height of rise in capillaries, (b) pressure of a gas bubble emerging into a liquid, (c) the ring method, (d) the Wilhelmy method, or (e) the method using the shape of supported or unsupported droplets (see, for example, Kohlrausch, Praktische Physik 1, pp. 200 et seq., Stuttgart, Teubner 1996; for the unsupported drop (pendant drop) method see also S. Wu, “Polymer Interface and Adhesion”, Marcel Dekker Inc., New York 1982, pp. 266-268). Values for the surface tension of liquids A are found by way of example in Handbook of Chemistry and Physics 76th Edition, CRC Press 1995, from 6-155 to 6-158. Similarly, the surface tension at the boundary between liquid A and substance B can be determined by (a) weighing methods which measure the force which has to be exerted to draw a sheet or hoop out of a liquid, (b) droplet volume methods, (c) the “spinning drop” method, (d) bubble pressure methods, and (e) the pendant drop method (see, for example, Kohlrausch, Praktische Physik 1, pp. 230 et seq., Stuttgart, Teubner 1985). The surface tension of some commercially available polymers B2 is given in the literature; see, for example, S. Wu et al. loc. cit. pp. 88 et seq., and S. Ellefson et al. J. Am. Ceram. Soc. 21, 193, (1938); S. Wu, J. Colloid Interface Sci. 31, 153 (1969), J. Phys. Chem. 74, 632 (1970), J. Polym. Sci., C34, 19, (1971); R. J. Roe et al., J. Phys. Chem. 72, 2013 (1968), J. Phys. Chem. 71, 4190 (1967), J. Colloid Interface Sci. 31, 228 (1969); J. F. Padday in Surface and Colloid Science (Editor E. Matijevic), Wiley, N.Y. 1969, pp. 101-149.

The surface tension at the boundary of substance B is preferably ≦50 mN/m, in particular is in the range from 5 to 45 mN/m, and specifically is in the range from 10 to 40 mN/m at 20° C., in particular when the liquid A is an aqueous liquid.

Examples of suitable substances B1 are

low-molecular-weight hydrocarbons, in particular saturated hydrocarbons having at least 8 carbon atoms, preferably at least 10 carbon atoms, in particular from 10 to 20 carbon atoms, e.g. octanes, nonanes, decanes, decalin, undecanes, dodecanes, tetradecanes, hexadecane, and mixtures of these;

perfluorohydrocarbons having at least 8 carbon atoms, preferably at least 10 carbon atoms, in particular from 10 to 40 carbon atoms, e.g. perfluorodecalins, perfluoroeicosanes, and perfluorotetracosanes, and mixtures of these; and

alkanols having at least 8 carbon atoms, preferably at least 10 carbon atoms, e.g. 3-octanol, 1-decanol, 2-decanol, undecanols, dodecanols, tridecanols, 2-hexadecanol, 2-hexyldecanol, and mixtures of these.

Particular other suitable substances B are polyisobutenes, which, depending on molecular weight, may be liquids, high-viscosity liquids, or solids. These generally have a number-average molecular weight in the range from 300 to 5×10⁶ dalton, in particular in the range from 600 to 3×10⁶ dalton.

Other particular suitable substances B are silicones, which, depending on molecular weight, may be liquids, high-viscosity liquids, or solids. These generally have a number-average molecular weight in the range from 200 to 10⁶ dalton, in particular in the range from 400 to 3×10⁵ dalton. The silicones are generally linear, branched, or cyclic polydimethylsiloxanes, or polymethylhydrosiloxanes. These may have the following groups G as end-groups or as side-chains: hydrogen, hydroxy groups, amino groups, C₁-C₂₀-alkyl groups, C₁-C₂₀-alkoxy groups, hydroxy-C₂-C₄-alkyl groups, formyl groups and C₁-C₂₀-alkylcarbonyl groups, carboxy-C₁-C₂₀-alkyl groups, amino-C₁-C₂₀-alkyl groups, amino groups, N-(2-amino-C₁-C₄-alkyl)amino-C₁-C₂₀-alkyl groups, glycidyl or glycidyloxy groups, methylpolyoxyethylenealkyl groups, hydroxypolyoxyethylenealkyl groups, methylpolyoxy-ethylenepolyoxypropylene groups, hydroxypolyoxyethylene groups, polyoxyethylene groups, phenyl groups, or perfluoro-C₁-C₂₀-alkyl groups. Examples of preferred groups G, besides hydrogen, are C₁-C₄-alkyl such as methyl or ethyl, OH, aminoalkyl, such as (CH₂)₁₋₁₀NH₂, methylpolyoxyethylenealkyl groups, such as (CH₂)₃—(OCH₂CH₂)₁₋₁₀—OCH₃, hydroxypolyoxyethylenealkyl groups, such as (CH₂)₃—(OCH₂CH₂)₁₋₁₀—OH, and amino groups, such as N(CH₃)₂. Polydimethylsiloxanes are generally composed predominantly of repeat units of the formula a, and polymethylhydrosiloxanes are generally mainly composed of repeat units of the formula b:

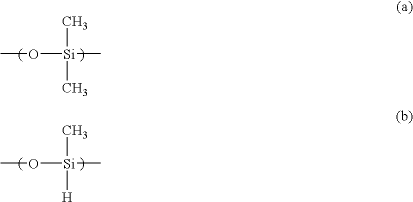

Where appropriate, they have one or more groups of the formula c:

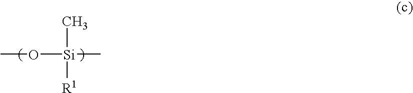

and end-groups of the formulae d and/or e:

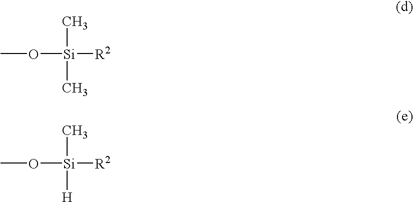

R¹ here is one of the abovementioned groups G other than hydrogen and methyl. R² is as defined for G.

The polydimethylsiloxanes, and also the polymethylhydrosiloxanes, may be linear or branched, or cyclic, preference being given to linear polydimethylsiloxanes and polymethylhydrosiloxanes. If the groups of the formula (c) are present, their arrangement in the siloxane chain may be random or in blocks.

Examples of suitable silicones are:

polydimethylsiloxanes with a molar mass of from 100 to 1000000 g/mol, preferably from 300 to 500000 g/mol, particularly preferably from 1000 to 200000 g/mol (number average);

polymethylhydrosiloxanes with a molar mass of from 200 to 1000000 g/mol, preferably from 400 to 400000 g/mol, particularly preferably from 800 to 150000 g/mol (number average);

hydrogen-terminated polydimethylsiloxanes with a molar mass of from 100 to 900000 g/mol, preferably from 400 to 500000 g/mol, particularly preferably from 500 to 200000 g/mol (number average);

silanol-terminated polydimethylsiloxanes with a molar mass of from 200 to 800000 g/mol, preferably from 400 to 500000 g/mol, particularly preferably from 500 to 300000 g/mol (number average);

amino-C₁-C₁₀-alkyl-terminated polydimethylsiloxanes with a molar mass of from 200 to 600000 g/mol, preferably from 300 to 400000 g/mol, particularly preferably from 400 to 300000 g/mol (number average);

hydroxy-C₁-C₁₀-alkyl-terminated polydimethylsiloxanes with a molar mass of from 100 to 500000 g/mol, preferably from 150 to 300000 g/mol, particularly preferably from 180 to 200000 g/mol (number average); and

glycidyloxy-terminated polydimethylsiloxanes with a molar mass of from 150 to 400000 g/mol, preferably from 180 to 200000 g/mol, particularly preferably from 200 to 250000 g/mol (number average).

Silicones of this type are known, e.g. from Moretto et al., Silicones, Chapter 3, in Ullmanns Encyclopedia of Industrial Chemistry, 5th edn. on CD-ROM, and are commercially available, for example with the trade name Rhodorsil (Rhodia) and from Gelest ABCR, Tullytown, Pa., USA.

Examples of other suitable substances B2 are:

poly(alkyl acrylates) and poly(alkyl methacrylates), and copolymers of alkyl acrylates and alkyl methacrylates, as long as these are liquid or have no flow threshold. Examples of these are polymethyl acrylate, poly(n-propyl acrylate), poly(isobutyl acrylate), poly(n-butyl acrylate), poly(tert-butyl acrylate), polymethyl methacrylate, poly(n-propyl methacrylate), poly(isobutyl methacrylates), poly(n-butyl methacrylate), poly(tert-butyl methacrylate);

polyesters preferably, such as poly(bisphenol A) terephthalate, poly(ethylene adipate), poly(ethylene terephthalate), poly(oxyethyleneoxyterephthaloyl), poly(oxypentamethyleneoxyterephthaloyl), poly(oxytetramethyleneoxyadipoyl).

The polymeric substances are suitable as long as at T1 they are liquid or have no flow threshold at T1.

The nature and structure of the surface are of lesser importance as long as the surface has many depressions and/or elevations and the average distance between adjacent elevations is in the range from 0.01 to 500 μm, in particular in the range from 0.05 to 200 μm, particularly preferably in the range from 0.1 to 100 μm, very particularly preferably from 0.2 to 80 μm, and specifically from 0.5 to 50 μm. The average height difference between mutually adjacent elevations and depressions is preferably in the range from 0.05 to 200 μm, and particularly preferably in the range from 0.1 to 100 μm, very particularly preferably from 0.2 to 80 μm, and specifically from 0.5 to 50 μm. This ensures uniform adhesion of the substance B on the substrate surface. In so far as the structure of the surface is substantially composed of depressions in a base surface or of elevations on a base surface, the ranges of values given above apply to the average heights (maxima) of the elevations above the base surface and, respectively, to the average depths (minima) of the depressions in the base surface.

The elevations/depressions may have a regular or irregular arrangement or may be of fractal character. Other suitable surface structures are those with irregularly arranged substructures which in turn have a regular arrangement. Examples of regular arrangements are waffle-pattern structures (isolated depressions in a flat surface), mountain-and-valley structures (=isolated elevations and isolated depressions, between which there are saddle areas, pillars and spikes (isolated elevations, e.g. pyramidal, block-shaped, irregular, or cylindrical, on a flat base structure), and stripes (=ribbon-shaped elevations on a flat surface, or linear depressions in a flat surface). Surface structures of this type are known and are described by way of example by Marzolin et al., Advanced Materials 1998, 10, pp. 571-574, Thin Solid Film 315, 1998, pp. 9-12. Examples of surfaces with irregularly arranged elevations/depressions are structures obtained, for example, by fixing particulate materials to surfaces which are per se flat. Fractal surface structures and their production are described by way of example by Shibuichi et al., J. Phys. Chem. 1996, pp. 19512-19517. Examples of surfaces with irregularly arranged substructures which in turn have a regular arrangement of elevations and depressions are the etched patterns obtainable when surfaces are etched.

The elevations/depressions may also have a fine structure, i.e. the elevations and depressions in turn have a number of elevations and/or depressions, and the distances and height differences between adjacent elevations/depressions of the fine structure are smaller by a factor of at least 5 than those of the associated main structures or overlying structures. The average distance/height difference in the fine structures may be in the range from 5 nm to 1000 nm, and in particular in the range from 10 nm to 500 nm, depending on the size of the overlying structure.

The production of surfaces which have many depressions and elevations is known per se. By way of example, the production of surfaces with a regular arrangement of elevations and depressions is possible by photolithographic processes, as described by way of example in U.S. Pat. No. 3,354,022, T. Ito et al., Jpn. J. Appl. Phys. 32 (1993) 6052, by embossing processes as described by Marzolin et al. (loc. cit.), Wilbur et al., Adv. Mater. 7, 1995, p. 649, Y. Xia et al., Langmuir 1996, 12, p. 4033, M. Toki et al., J. Non Cryst. Solids, 1988, 100, p. 479, a sol-gel process being used where appropriate here to form the structures, or by combining photolithographic and embossing processes as described in EP-A 933 388 and by Marzolin et al. (loc. cit.). Substrates with surfaces which have many regularly arranged depressions and elevations in the size range given are also commercially available, e.g. as Truegrain® from Autotype International Ltd., Wantage, Oxon., United Kingdom.

Surfaces with an irregular arrangement of elevations and depressions are a preferred embodiment of the invention, and can be produced in a particularly simple manner by applying a finely divided particulate material of suitable size to a surface of an article, the surface being smooth per se, and fixing the material to the surface. Preference is given here to those particulate materials, also termed powders below, in which the particle sizes of 90% by weight of the particles are in the range from 0.01 to 500 μm, in particular in the range from 0.05 to 200 μm, particularly preferably in the range from 0.1 to 100 μm, very particularly preferably in the range from 0.2 to 80 μm, and specifically from 0.5 to 50 μm. The powder may be inorganic or organic in nature. The powder particles may have a regular structure, e.g. a spherical or ellipsoidal structure, or may have an irregular structure, e.g. a fractal structure, or a porous structure, or a structure formed by agglomeration. Examples of suitable particulate materials are organic powders, e.g. polymer powder, such as polyethylene powder, polypropylene powder, polytetrafluoroethylene powder, and bioorganic powders, such as lycopodium, and also inorganic powders, such as those based on silicon dioxide or on silicates, for example silica powder, e.g. precipitated silica, diatomaceous earth, fumed silica, porosils, and silica gel powder, clay minerals, powdered quartz, powdered glass, e.g. glass beads, and aluminum oxide, zeolites, and titanium dioxide, and oxidic powders here may also have been hydrophobicized with fluorinated organic silanes.

The amount of the powder applied is generally sufficient to give complete, at least 95%, covering of the surface by the powder particles.

The powder particles may be fixed in any desired manner, which is of relatively little importance for the success of the process of the invention. For example, a surface may be provided with a pressure-sensitive adhesive. The powder is then usually applied by scattering. The excess powder, i.e. the powder not fixed, is then shaken off or blown off using a stream of air. Instead of the pressure-sensitive adhesive, use may also be made of a photo-crosslinkable adhesive or of a curable coating material, e.g. a photo-crosslinkable or hot-curing coating material. The powder is then applied in the manner described above, and is fixed by curing the adhesive or layer of coating material, e.g. by UV radiation. Any desired materials may be used as carriers for the powder particles or for the adhesives, examples being plastic films, metal, coated metal, ceramics, paper, leather, wood, and also fibers and yarns, and also construction materials, such as masonry, concrete, tiles, plaster surfaces, and the like.

The desired surfaces may also be obtained by chemical etching methods, e.g. by etching with acid or with a solvent, or by physico-chemical etching methods, e.g. using plasma radiation, ion etching in the presence of oxygen, or the like.

The character of the article or substrate possessing the surface, also termed substrate material below, is of relatively little importance for the success of the invention. Under the usage conditions, i.e. in the temperature range [T1; T2] within which low wettability is desired, the substrate material is naturally solid and gives a stable level of roughness, i.e. at temperatures above T1 it is unlike the polymeric substance B2 in having a high flow threshold or being incapable of plastic deformation. It has preferably been matched to the substance B in such a way that the contact angle on the given roughness is <10°.

The substrate may be composed uniformly of one material, i.e. elevations/depressions and any surface areas present between these are composed of one material. However, the substrate may also be composed of two or more materials. This is frequently the case when the substrate has been produced by applying particulate substances to a carrier. The substrate is then composed of the carrier material, the particles which form the elevations/depressions, and, where appropriate, any means used to fix the particles to the carrier. The properties of the surface are generally unaffected by the carrier.

Examples of substrate materials are metals, such as iron, iron-containing alloys, e.g. steels, conventional coated surfaces, semimetals, such as silicon, and ceramic materials, plastics, e.g. polyolefins, such as polyethylene and polypropylene, polyesters, such as polyethylene terephthalate, polyvinyl chloride, polystyrene, polyalkyl methacrylates, diene rubbers, EPDM rubbers, ABS, polyarylene ethers, polyether sulfones, polyurethanes, polyamides, polyacrylonitrile, styrene-acrylonitrile, polycondensation resins, and in particular crosslinked siloxanes, for example those produced during condensation of organosilanols, and also blends of the abovementioned plastics, and composites of plastics with inorganic fillers.

The substance B may be applied in a conventional manner to the surface of the article, for example by dipping, spraying, rolling, spin-coating, frictional application, or migration, utilizing the capillary forces exerted by the surface. The last method is one preferred embodiment of the invention, and is in particular preferred for applying liquid substances B1.

When applied to the surface, the substance B is generally in liquid form or in dissolved form. If the substance B has been selected from liquids B1, it preferably has a viscosity ≦10000 mm²/sec and in particular ≦5000 mm²/sec, e.g. in the range from 5 to 10000 mm²/sec (at 20° C.). The viscosity given here is the kinematic viscosity, for example as can be determined using an Ubbelohde viscometer to DIN 51562-1 to 4. Uniform application of the substance B becomes easier when the viscosity is within that range.

If the substance B has a higher viscosity, or indeed is solid, it is advisable to dilute the substance B with a solvent or to dissolve it therein. This applies in particular when the substance B has been selected from polymeric substances B2. In this case, B2 is in the form of a solution in a low-molecular-weight solvent when applied to the surface. The viscosity of the solution here is preferably adjusted to values ≦10000 mm²/sec and in particular ≦5000 mm²/sec, e.g. in the range from 5 to 10000 mm²/sec (at 20° C.). The selection of the solvent is of relatively little importance for the success of the process of the invention, and mainly depends on the substance B, for which it should be a good solvent. In addition, the solvent should cause no breakdown of the surface structure, and should be sufficiently volatile to be easily removable. The skilled worker will be able to find suitable solvents, using simple trials. Examples of suitable solvents are hydrocarbons, such as aliphatics, cycloaliphatics, gasoline, xylene, toluene; alcohols, such as ethanol, isopropanol, butanol, tert-butanol; ketones, such as acetone, methyl ethyl ketone, methyl isobutyl ketone, diethyl ketone, and ethers, e.g. tetrahydrofuran, diisopropyl ether, di-n-propyl ether, methyl tert-butyl ether, dioxane, and mixtures of the abovementioned solvents.

The temperature at which the substance B is applied is of relatively little importance for the success of the invention. The temperature selected will generally be one at which the substance B is liquid or has no remaining flow threshold. In other words, the substance B is generally applied at temperatures in the range T1 and above. The substance B can also be applied at temperatures markedly higher than T1, for example at temperatures above T1 by at least 20 K, in particular by at least 30 K, and particularly preferably by at least 50 K, in order to reduce the viscosity of the substance B. However, the temperature of the substance may also be below T1 when it is applied to the surface, where appropriate with the aid of a solvent.

According to the invention, the amount of the substance B applied to the surface is sufficient for complete covering of the surface. Complete covering of the surface means an at least monomolecular layer of substance B. For complete covering, the degree of covering is at least 99% of the surface. Complete covering is generally achieved by applying at least 10⁻³ g/m² of substance B, preferably at least 5*10⁻³ g/m², in particular at least 10⁻² g/m². The amount of substance B applied is in particular in the range from 10⁻³ g/m² to 100 g/m², preferably in the range from 5*10⁻³ g/m² to 80 g/m², and in particular in the range from 10⁻² g/m² to 50 g/m², particularly preferably from 10⁻² g/m² to 10 g/m², and specifically from 10⁻² g/m² to 5 g/m².

The surfaces thus obtained, and therefore also the articles or substrates which have this surface, are novel and are likewise provided by the invention. At a usage temperature T≦T1, liquids A have no, or only slight, adhesion to these surfaces, this paucity or absence of adhesion being expressed in terms of a contact angle hysteresis Δθ=θₐ−θᵣ of not more than 40°, in particular not more than 20°, and in particular not more than 10°. Even at small angles of inclination, the run-off of the liquids A from the surfaces of the invention is rapid, and there is therefore free movement on the surfaces. The result is no drying of the liquid droplets, so that no deposits form. Dirt particles are very easily and rapidly washed away from the surfaces by the liquids A. In addition, the optical properties of the untreated surfaces are retained.

The process of the invention is in particular suitable for producing surfaces which are not wetted, or are only slightly wetted, by alcohols, in particular polyols, such as glycerol and glycol, or by aqueous liquids, or to which these liquids do not adhere, or adhere only slightly. Aqueous liquids here and below are liquids which comprise at least 60% by volume, in particular at least 80% by volume, of water, based on the liquid constituents of the liquid. Other examples of aqueous liquids, besides water, are aqueous alkalis and acids, solutions in water of inorganic or organic materials, e.g. of salts, of sugars, of starch, of proteins, of surfactants, of alcohols, or of polymers, and also aqueous emulsions, dispersions, and suspensions.

The advantageous properties of the surfaces of the invention make them suitable for a wide variety of applications. For example, these surfaces can be used on articles exposed to severe soiling. This method not only reduces the soiling of the articles but also reduces corrosion resulting from soiling. The surfaces of the invention can also be used on the inner walls of tanks, the inner walls of storage containers for solids, the inner walls of pipelines and of chemical apparatus, and the like. The result is lower adhesion of liquids to the container walls. The self-cleaning action of the surface also reduces formation of deposits and permits easier removal of solid residues by cleaning.

The following non-limiting drawings and examples provide illustration of the invention.

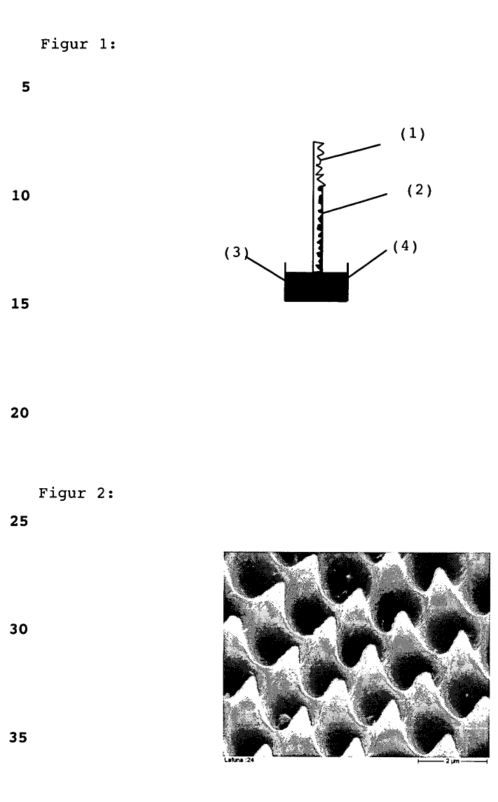

FIG. 1 is a diagram of an experimental arrangement for the coating of a substrate (1) with a liquid substance B, utilizing capillary forces. To this end, the substrate (1) is placed with one edge in a storage vessel (4) filled with the liquid substance B (3). Capillary forces here cause this substance B to migrate counter-gravitationally into the depressions of the substrate surface, thus forming a thin liquid film (2) on the surface of the substrate.

FIG. 2 shows a scanning electron micrograph of the surface of a polyester film with a regular mountain-valley arrangement of elevations and depressions. The average distance between two depressions separated by any saddle area is about 2 μm, and the average height difference between the elevations and depressions is about 10 μm.

### EXAMPLES

I. Analysis

Determination of static, advancing, and receding contact angle, using a microscope equipped with a goniometer.

Determination of surface tension and surface tension at the boundary: pendant-drop method, e.g. as described by O. I. del Rio et al., J. of Colloid Interface Sci. 196 (1997), p. 136, J. P. Garandert et al., J. of Colloid Interface Sci. 1994, pp. 165, 351, K. Mysels, Colloid Surfaces 43 (1990), p. 241.

2. Preparation of Coated Substrates

### Example 1

Spherical particles of lycopodium (average particle size about 20 μm), commercially available from Fluka, were applied to an adhesive tape (TF) (Tesa Film, 1×1 cm, obtainable commercially from Beiersdorf), by scattering lycopodium on the adhesive tape and removing excess powder by blowing.

In an experimental arrangement as in FIG. 1, the resultant substrate was immersed for 48 h with one edge (depth 1 mm) in a liquid polydimethylsiloxane (Rhodorsil 48V100, available commercially from Rhodia Chimie, viscosity η (20° C.)=102.5 cSt). The polydimethylsiloxane here migrated counter-gravitationally into the depressions of the structure.

The static contact angle of water on the untreated surface of the substrate was 145°, and the static contact angle of the silicone oil on the untreated surface was <10°. The surface tension γ_{H2O} was 72 mN/m, and that of the polydimethylsiloxane γ_{PS} was 20.9 mN/m. The surface tension γ_{H2O/PS} at the boundary was 30.1 mN/m (all values at 20° C).

The advancing contact angle θₐ and the receding contact angle θᵣ of water were determined for the substrate surface treated according to the invention, and for the untreated surface, for comparative purposes. The values found and the contact angle hysteresis calculated from these are given in Table 1.

### Example 2

Using a method similar to that of Example 1, the substrate shown in FIG. 2 (available commercially as Truegrain MV from Autotype International Ltd., UK) was treated with a liquid, silanol-terminated polydimethylsiloxane (Silikon DMS-S12 from Gelest ABCR, viscosity η (20° C.)=26 cSt).

The static contact angle of water on the untreated surface of the substrate was 104°, and the static contact angle of the silicone oil on the untreated surface was <10°. The surface tension γ_{H2O} was 72 mN/m, and that of the polydimethylsiloxane γ_{PS} was 19 mN/m. The surface tension γ_{H2O/PS} at the boundary was 27.7 mN/m (all values at 20° C.).

The advancing contact angle θₐ and the receding contact angle θᵣ of water were determined for the substrate surface treated according to the invention, and for the untreated surface, for comparative purposes. The values found and the contact angle hysteresis calculated from these are given in Table 1.

TABLE 1

| | Example 1 | | Example 2 | |
|---|---|---|---|---|
| | untreated | treated | untreated | treated |
| θₐ H₂O | 145° | 101° | 104° | 74° |
| θᵣ H₂O | 0° | 81° | 0° | 72.5° |
| Δθ | 145° | 20° | 104° | 1.5° |

### Examples 3-7

Using a method similar to that of Example 2, a specimen of the substrate used in that example was treated with each of the following: decanol (viscosity η (20° C.)=12.4 cSt), 2-hexyldecan-1-ol (viscosity η (20° C.)=31.3 cSt), a polymethylhydrosiloxane (HMS 991 from Gelest ABCR, viscosity η (20° C.)=22.5 cSt), a silanol-terminated polydimethylsiloxane (Silikon DMS-S21 from Gelest ABCR, viscosity η (20° C.)=88.3 cSt), and a polydimethylsiloxane (Rhodorsil 48V100, available commercially from Rhodia Chimie, viscosity η (20° C.)=102.5 cSt). The static contact angle for these substances was in all cases <10°. The results are given in Table 2.

TABLE 2

| | Ex. 3 | Ex. 4 | Ex. 5 | Ex. 6 | Ex. 7 |
|---|---|---|---|---|---|
| Substance B | Decanol | 2-Hexyl- | HMS 991¹⁾ | S21²⁾ | 48V100³⁾ |
| | | decanol | | | |
| γ_{B} [mN/m] | 9.0 | 26.1 | 21.5 | 28.5 | 30.1 |
| γH2O/_{B} [mN/ | 28.8 | 27.1 | 19.7 | 20.4 | 20.9 |
| m] | | | | | |
| θₐ H₂O | 54° | 86° | 89° | 89° | 90° |
| θᵣ H₂O | 49° | 83° | 88° | 89° | 88° |
| Δθ | 5° | 3° | 1° | 1 | 2° |

¹⁾polymethylhydrosiloxane
²⁾Silikon DMS-S21
³⁾Rhosorsil 48V100

III. Dirt Removal Test

A specimen from Example 1 was soiled by scattering with silica gel 60, from 0.04 to 0.063 mm (available commercially from Merck). Water was then applied dropwise to the specimen, which had been inclined at 20° from the horizontal. The water droplets run off the surfaces and thereby remove the dirt particles. The effectiveness of dirt removal was 95% increased in comparison with an untreated MV specimen without silicone oil. The droplets do not run off the reference specimen at an inclination angle of 20°.

We claim:

1. A process for producing articles or substrates with at least one surface on which a liquid A has low adhesion at a temperature T≧T1, by applying a substance B in liquid or in dissolved form to a surface S of the substrate or article in an amount which covers the surface, which comprises using a surface S which has many depressions and/or elevations, where the average distance between adjacent elevations is in the range from 0.01 to 500 μm and the average height difference between mutually adjacent elevations and depressions is in the range from 0.01 to 500 μm, the substance B is immiscible with the liquid A and soluble therein to an extent of less than 0.1 g/l (at 20° C. and 1013 mbar), and has been selected from low-molecular-weight and oligomeric substances B1 which are liquid at the temperature T1 and plastic polymeric substances B2 which do not have a measurable flow threshold at temperatures ≧T1.

2. A process as claimed in claim 1, wherein the substance B has a static contact angle θ_{B}<10° (at 20° C. and 1013 mbar) on the surface.

3. A process as claimed in claim 1, wherein the selection of the substance B is such that it complies with the relationship of formula I:
γ_{B}* cos(θ_{B})−γ_{A}* cos(θ_{A})−γ_{A/B}>0 (I)
where
γ_{A} is the surface tension of the liquid A
θ_{A} is the static contact angle of the liquid A on the untreated surface S
γ_{B} is the surface tension of the substance B
θ_{B} is the static contact angle of the liquid substance B on the untreated surface S, and
γ_{A/B} is the surface tension at the boundary between liquid A and substance B.

4. A process as claimed in claim 1, wherein the substance B has been selected from liquids with a kinematic viscosity ≦10000 mm²/sec (at 20° C.).

5. A process as claimed in claim 1, wherein the amount of the substance B applied to the surface is from 10⁻³ g/m² to 100 g/m².

6. A process as claimed in claim 1, wherein the temperature T1 is at least −10° C.

7. A process as claimed in claim 1, wherein the liquid A has been selected from aqueous liquids.

8. A process as claimed in claim 1, wherein the surface tension of the substance B at its boundary is ≦50 mN/m at 20° C.

9. A process as claimed in claim 1, wherein the substance B has been selected from hydrocarbons having at least 8 carbon atoms, perfluorohydrocarbons having at least 8 carbon atoms, alkanols having at least 8 carbon atoms, silicones, polyisobutenes, poly(alkyl acrylates), poly(alkyl methacrylates), and polyesters.

10. An article which has at least one surface which is obtainable by a process as claimed in claim 1.
